(19) United States
(12) Patent Application Publication
(10) Pub. No.: US 2015/0006329 A1
(43) Pub. Date: Jan. 1, 2015

(54) DISTRIBUTED ERP

(71) Applicants: GIRIDHARAN SOMASKANDAN, Kanchipuram (IN); Bikash Prakash MISHRA, Bangalore (IN); Karthikeyan R, Rasipuram (IN)

(72) Inventors: GIRIDHARAN SOMASKANDAN, Kanchipuram (IN); Bikash Prakash MISHRA, Bangalore (IN); Karthikeyan R, Rasipuram (IN)

(21) Appl. No.: 13/930,217

(22) Filed: Jun. 28, 2013

(51) Int. Cl. G06Q 10/08; G06Q 30/06

(52) U.S. Cl. CPC G06Q 10/087; G06Q 30/0635
USPC 705/26.81; 705/28

(57) ABSTRACT

Various embodiments of systems and methods for distributed enterprise resource planning (ERP) are described herein. In one aspect, the method includes identifying one or more components of an enterprise resource planning system. A signal from one of the identified component is received. Based upon the received signal, a routine unit performs a task. The task includes at least one of updating a database table related to inventory of the ERP system, executing an application related to the ERP system to generate information to be sent to another identified component, and when the received signal includes data, transferring the data to another component of the identified one or more components.

### BACKGROUND

Enterprise resource planning (ERP) system facilitates flow of information within an organization and manages connections with outside stakeholders. Typically, ERP systems are centralized, and often, web-based application. Centralized web-based applications can be accessed using the Internet and are operable in online mode, Therefore, in case of internet connectivity issues, tasks related to such ERP systems cannot be performed. Further, installing and operating centralized ERP systems usually require sizable and costly centralized computer systems or servers, e.g., including powerful central processing unit (CPU) or units, voluminous random access memory (RAM), hard disk or disks, etc. Also, the subscription charge of centralized ERP systems could be very high. Therefore, such sizable centralized ERP systems might not be preferable, especially by small and medium scale organizations where the flow of information or the business transactions are relatively not as many.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a distributed ERP system including a routing unit for managing flow of information between various components of the distributed ERP system, according to an embodiment.

FIG. 2 is a block diagram illustrating the components of a distributed ERP system, according to an embodiment.

FIG. 3 is a table illustrating database structure included within a routing unit, according to an embodiment.

FIG. 4 is a block diagram of a distributed ERP system related to trading, according to an embodiment.

FIG. 5 is a document illustrating a sales order created by a sales unit of a distributed ERP system, according to an embodiment.

FIG. 6 is a table illustrating a sales database structure included within a sales unit of a distributed ERP, according to an embodiment.

FIG. 7 is a document illustrating a delivery order generated by the routing unit, according to an embodiment.

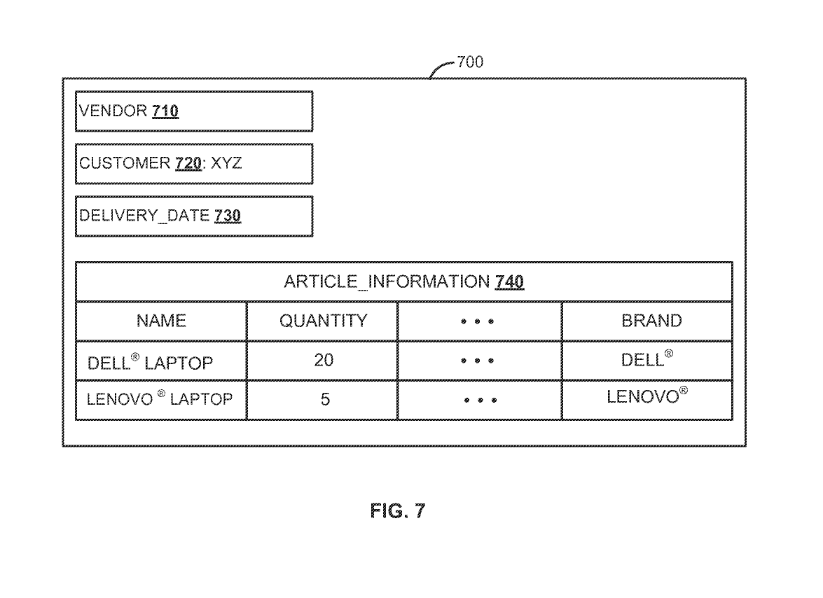

FIG. 8 is a table illustrating an updated database structure of a routing unit, according to an embodiment.

FIG. 9 is a document illustrating a purchase requisition generated by a routing unit, according to an embodiment.

FIG. 10 is a document illustrating a purchase order corresponding to a purchase requisition generated by a procurement routing unit of a distributed ERP system, according to an embodiment.

FIG. 11 is a document, illustrating an inbound delivery generated by a routing unit, according to an embodiment.

FIG. 12 is a document illustrating an outbound delivery generated by a warehouse unit of a distributed ERP system, according to an embodiment.

FIG. 13 is a flow chart for managing flow of information between various components of a distributed ERP system, according to an embodiment.

FIG. 14 is a block diagram of an exemplary computer system, according to an embodiment.

### DESCRIPTION

Embodiments of techniques for distributed ERP are described herein. It he following description, numerous specific details are set forth to provide a thorough understanding of the embodiments. One skilled in the relevant art will recognize, however, that the embodiments can be practiced without one or more of the specific details, or with other methods, components, materials, etc. in other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one Of more embodiments. Thus, the appearances of these phrases in various places throughout this specification are not necessarily all referring to the same embodiment Furthermore, the particular features, structures, or characteristics may be combined in any suitable manner in one or more embodiments.

An ERP system may include different components or functional units. For example, an ERP system related to trading comprises components such as a sales unit, a procurement unit, a finance unit, a warehouse unit, etc. The components perform tasks corresponding to their functionality. A task performed by one component may be dependent on the task performed by another component. In one embodiment, one or more different components or functional units of an ERP system may be executed on different devices, including mobile devices. In one embodiment, such components may include their respective database and application. An application may be software that causes a component to perform its task. For example, the component “sales unit” includes an application to generate sales orders.

A routing unit may regulate a flow of information between various components of the ERP system. The components of the ERP system may be registered with the routing unit. In one embodiment, the routing unit routes information based upon a signal or an instruction received front one of the various registered components of the ERP system. In one embodiment, the routing unit may be an intelligent unit which performs tasks based upon some analysis, e.g., by analyzing an inventory database. In one embodiment, the routing unit may be an application installed on a server. In one embodiment, the routing unit may be a server.

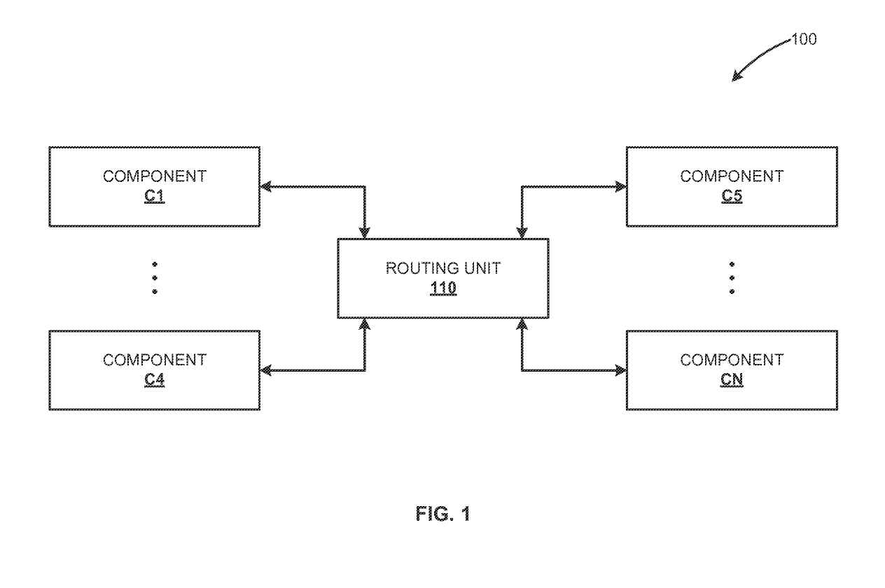

FIG. 1 illustrates one embodiment of a distributed enterprise resource planning (ERP) system 100 including a routing unit 110 for managing flow of information between various components, e.g., C1-CN, of the distributed ERP system 100. The components C1-CN are registered with the routing unit 110. The routing unit 110 receives a signal from any of the registered components, e.g., C1. The signal may comprise at least one of data, instruction, document, etc. Based upon the received signal, the routing unit 110 may update a database (no(shown) related to inventory of the distributed ERP system 100. Such database may be included in the routing unit 110. When the signal is received, the routing unit 110 analyzes the database to determine tasks to be performed. For example, the routing unit 110 may analyze the database to determine whether to execute an application related to the ERP. The application is executed to generate information to be sent to one or more of the other components, e.g., C2-CN. In one embodiment, the routing unit 110 determines whether the received signal includes data which has to be transferred to another component. When the signal includes the data that has to be transferred, the routing unit 110 transfers the data to the another component of the distributed ERP system 100.

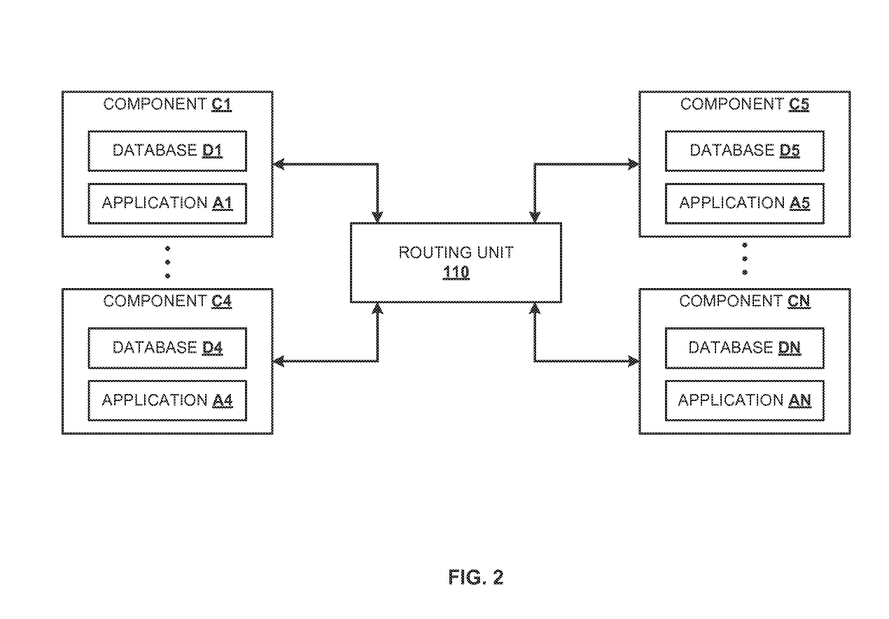

In ERP system 100, the components C1-CN may have their respective database and application. FIG. 2 illustrates the components C1-CN along with their respective database and application. For example, the component C1 has a database D1 and an application A1, component C4 has a database D4 and an application A4, component C5 has a database D5 and an application A5, and component CN has a database DN and an application AN. Therefore the component database and application can be accessed on premise or offline. For example, if the component C1 is a sales unit then a sales manager can create a sales order or can access a sales database on premise or offline. In one embodiment, a task of a component might depend upon the task performed by another component. Therefore, a flow of information is maintained between the components C1-CN. The routing unit 110 maintains the flow of information between the components C1-CN.

The routing unit 110 is communicatively coupled to the components C1-CN. In one embodiment, the components C1-CN are registered with the routing unit 110. The routing unit 110 can identify the registered components C1-CN. The routing unit 110 may include a register (not shown) which includes the names and the internet protocol (IP) addresses of the components which are registered. The routing unit 110 reads the register to identify the components C1-CN. In one embodiment, the routing unit 110 can receive a signal from any of the identified components, e.g., C1. In one embodiment, the signal comprises at least one of an instruction, a document, some data, etc. For example, the signal may comprise the sales order, a purchase order, etc. Based upon the signal, the routing unit 110 performs one or more tasks.

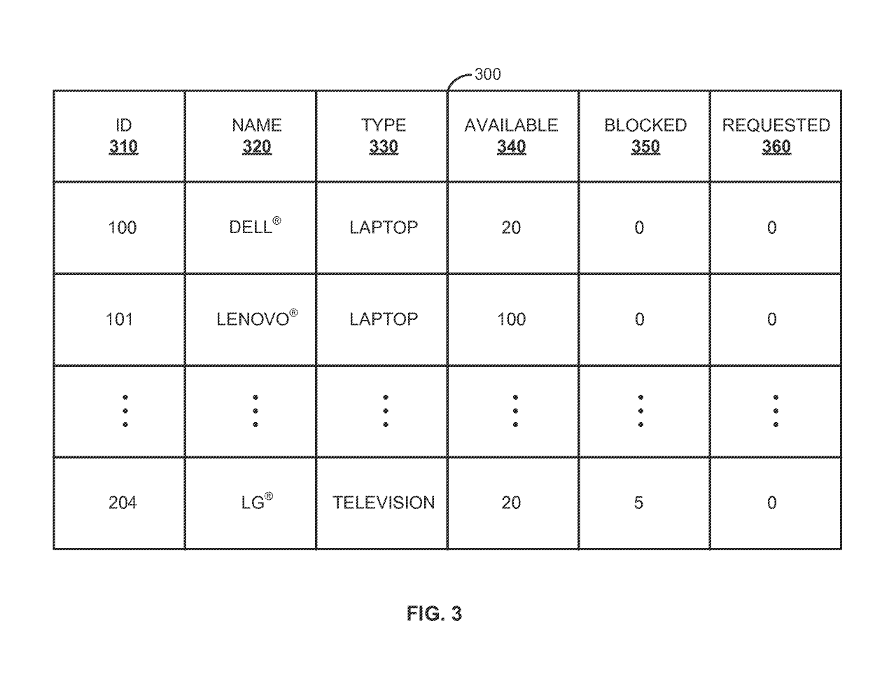

In one embodiment, the routing unit 110 includes a database table (not shown) related to the ERP operation it is controlling. For example, when the routing unit 110 is controlling a trading operation, the routing unit 110 may refer to a database table related to an inventory or stock. The database table may be similar to table 300 illustrated in FIG. 3, according to one embodiment. The routing unit 110 may refer to the database table 300 to determine one or more tasks to be performed by the routing unit 110. In one embodiment, the routing unit 110 updates the database table 300 in real-time.

Referring to FIG. 3, the database table 300 includes fields such as ID 310, NAME 320, TYPE 330, AVAILABLE 340, BLOCKED 350, and REQUESTED 360. The ID 310 is a unique identifier assigned to various articles in the inventory. In one embodiment, the ID 310 is automatically generated by the routing unit 110. In one embodiment, the ID 310 may be alphabetical, numerical, or alphanumeric character. The NAME 320 is a name of respective article. The NAME 320 may be a brand name of the article, e.g., Dell®, LG®, Lenovo®, etc. The TYPE 330 indicates the type of the article, e.g., Television, Laptop, etc. AVAILABLE 340 indicates a number or quantity of the article available in stock. For example, as shown, 20 Dell® laptops are available in stock. BLOCKED 350 indicates a number Of quantity of the article that is already booked by a customer. For example, as shown, 5 LG® Televisions are already blocked for the customer. Typically, there are 25 LG® Televisions in stock, of which 5 are booked and 20 are available. REQUESTED 360 indicates a number of the article requested by a customer which are not yet blocked, e.g., may be due to unavailability of the articles. The fields ID 310, NAME 320, TYPE 330, AVAILABLE 340, BLOCKED 350, and REQUESTED 360 may be updated by the routing unit 110 in real-time.

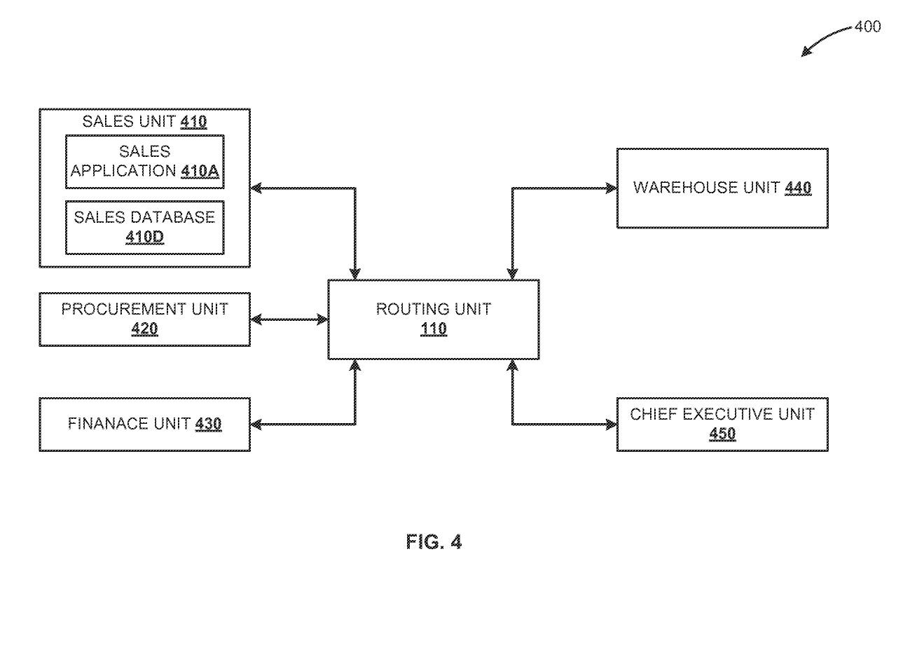

FIG. 4 illustrates distributed ERP system 400 related to trading, according to one embodiment. The distributed ERP system 400 includes sales unit 410, procurement unit 420, finance unit 430, warehouse unit 440, and chief executive unit 450 components. A sales manager of the sales unit 410 may receive an order or request for an article from a customer “XYZ”. For example, the customer “XYZ” may request for 20 Dell® laptops and 5 Lenovo® laptops.

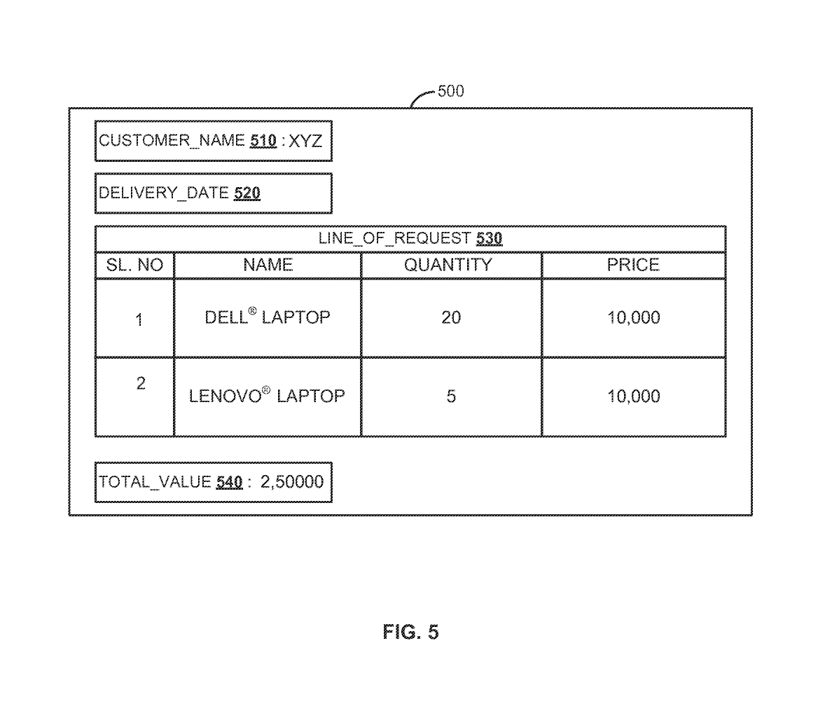

Referring to FIG. 5, the sales manager creates a sales order 500 for the customer “XYZ” with a set of requested articles, i.e., 20 Dell® laptops and 5 Lenovo® laptops. The sales order 500 is created by executing sales application 410A included within the sales unit 410 in FIG. 4. In one embodiment, the sales order 500 is a document comprising fields such as CUSTOMER_NAME 510 indicating the name of the customer, e.g., “XYZ”, DELIVERY_DATE 520 indicating the date by which the articles are requested to be delivered to the customer, LINE_OF_REQUEST 530 indicating various information related to the articles requested by the customer, e.g., name, quantity, price per item, etc., and TOTAL_VALUE 540 indicating a total amount or a price of the requested articles.

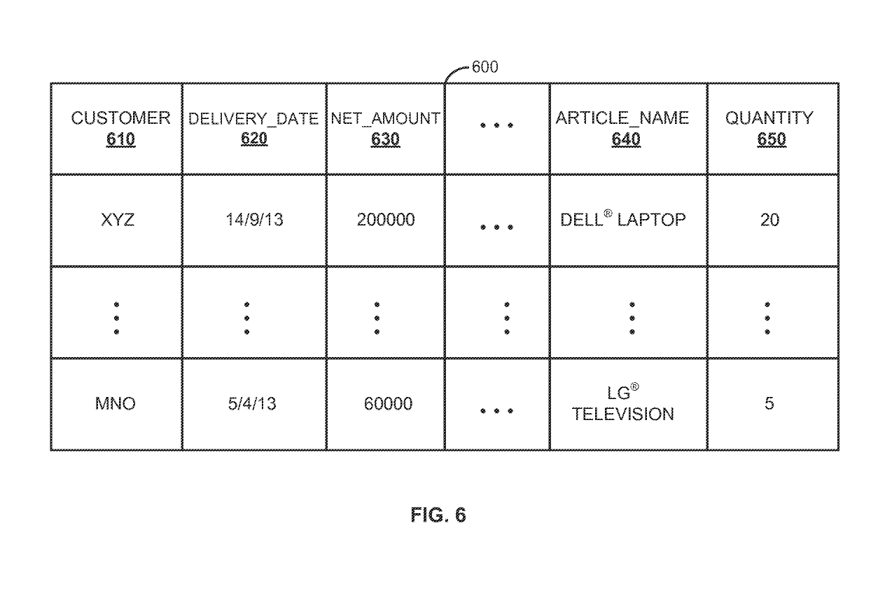

Based upon the sales order 500, the sales unit 410 automatically updates the sales database 410D. Typically, the information related to the sales order 500 is stored in the sales database 410D. In one embodiment, the sales database 410D may include data structure as illustrated with table 600 in FIG. 6 with fields such as CUSTOMER 610 to indicate the name of the customer, e.g., “XYZ”, DELIVERY_DATE 620 to indicate the date by which the article has to be delivered, NET_AMOUNT 630 to indicate the total price of the articles requested by the customer, ARTICLE_NAME 640 to indicate the name of the articles requested, e.g., Dell® laptop, and QUANTITY 650 to indicate the number of the articles requested.

In one embodiment, when the sales database 410D in FIG. 4 is updated, the sales unit 410 informs the routing unit 110, e.g., about the sales order 500 when the sales order 500 is created. The sales unit 410 may send a signal to the routing unit 110 indicating that a new sales order is created. The signal may include data such as CUSTOMER_NAME 510, DELIVERY_DATE 520, LINE_OF_REQUEST 530, and TOTAL_VALUE 540 related to the sales order 500, in one embodiment, the signal includes the sales order 500 itself.

When the routing unit 110 receives the signal regarding the sales order 500, the routing unit 110 reads the database table 300 to determine whether the requested articles are available in stock. In case the requested articles, e.g., 20 Dell® laptops and 5 Lenovo® laptops, are available, the routing unit 110 generates a delivery order 700 (refer to HG, 7). In one embodiment, the delivery order 700 is generated irrespective of the availability of the requested articles.

The delivery order 700 comprises fields such as VENDOR 710, CUSTOMER 720, DELIVERY_DATE 730, and ARTICLE_INFORMATION 740. VENDOR 710 indicates the name of the vendor, CUSTOMER 720 indicates the name of the customer requesting the article, e.g., “XYZ”, and DELIVERY_DATE 730 indicates the date by which the requested articles have to be delivered to the customer. The ARTICLE_INFORMATION 740 indicates various information related to the requested articles, e.g., name, quantity, brand, etc. The delivery order 700 is then sent to a delivery manager in the warehouse unit 440 (FIG. 4). In one embodiment, the routing unit 110 transfers VENDOR 710, CUSTOMER 720. DELIVERY_DATE 730, and ARTICLE_INFORMATION 740 to the warehouse unit 440 and the warehouse unit 440 generates the delivery order 700. In one embodiment, the delivery order 700 is stored in the warehouse unit 440.

Based upon the delivery order 700, the warehouse unit 440 issues the requested articles, Once the articles are issued, the warehouse unit 440 informs the routing unit 110. The routing unit 110 informs the finance unit 430 about the issuance of requested articles. In one embodiment, the routing unit 110 creates billing for the requested articles and sends the billing to the finance unit 430. In one embodiment, the routing unit 110 sends the billing to the finance unit 430 when the sales order 500 is created. Once the issuance of the articles is confirmed, the finance unit 430 dispatches the billing to the customer “XYZ”.

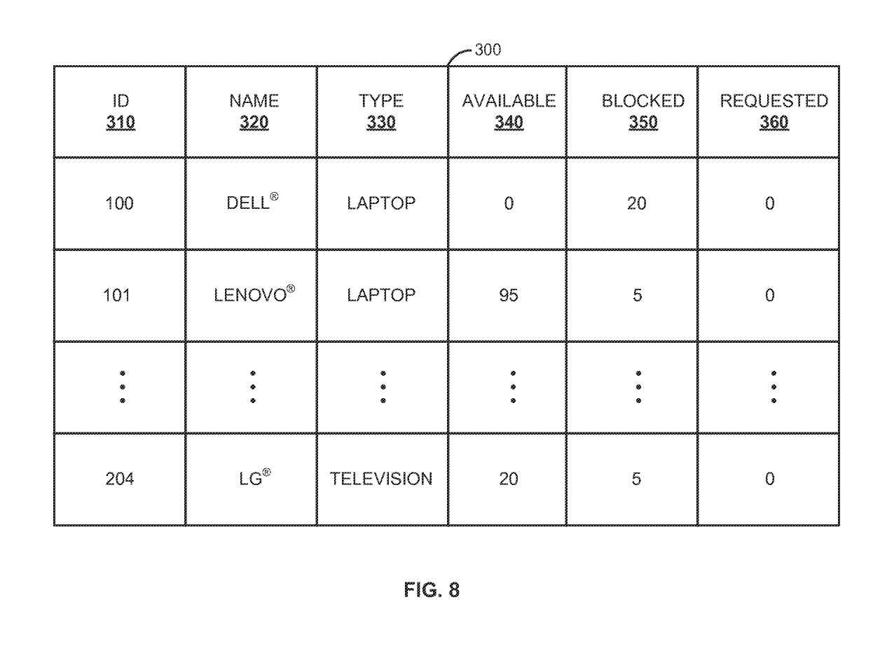

In one embodiment, based upon the requested articles, the routing unit 110 updates the inventory information or the database table 300. FIG. 8 illustrates the updated database table 300. The routing unit 110 may update only fields AVAILABLE 340, BLOCKED 350, and REQUESTED 360 of the database table 300. For example, based upon the request for 20 Dell® laptops, the routing unit 110 updates the value of AVAILABLE 340 field and BLOCKED 350 field for Dell® laptops. For example, the value of AVAILABLE 340 field is changed from ‘20’ to ‘0’ as the ‘20’ available Dell® laptops got booked for the customer and now nothing is available. The value of BLOCKED 350 field for Dell® laptops is changed from ‘0’ to ‘20’ as initially none of the Dell® laptops was booked and now ‘20’ Dell® laptops gat booked. Similarly, based upon the request of 5 Lenovo® laptops, the routing unit 110 updates the value of AVAILABLE 340 field and BLOCKED 350 field for Lenovo® laptops. The routing unit 110 reads the database table 300 to determine the availability of the requested articles.

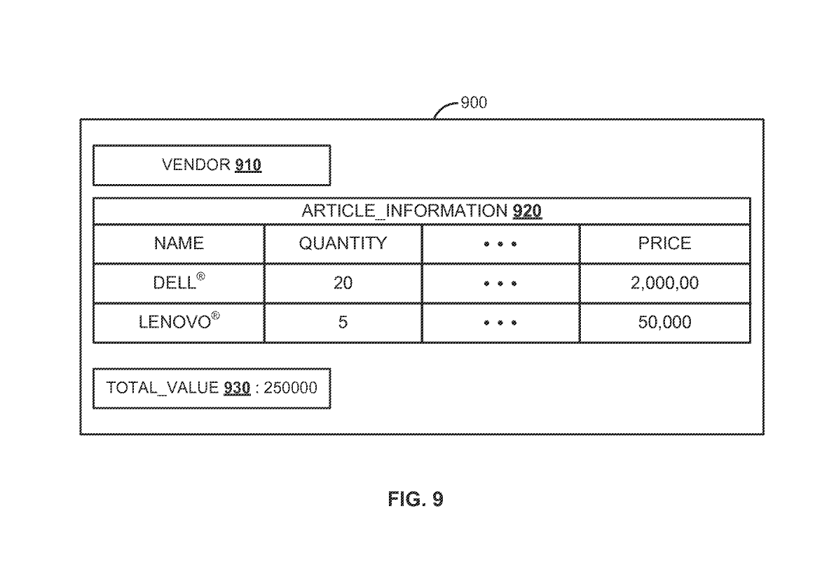

In case the requested articles are not available in stock, the routing unit 110 may execute material requirement planning (MRP) application (not illustrated). The MRP application is executed to generate a purchase requisition 900, as shown in FIG, 9, according to one embodiment. The purchase requisition 900 shown in FIG. 9 is one of various samples of purchase requisition. The purchase requisition 900 includes fields such as VENDOR 910, ARTICLE_INFORMATION 920, and TOTAL_VALUE 930. The VENDOR 910 field may be left blank by the routing unit 110 as the VENDOR 910 information may be provided by a procurement manager of the procurement unit 420 (FIG. 4). The ARTICLE_INFORMATION 920 includes information related to the requested articles such as name, quantity, price, etc. The TOTAL_VALUE 930 field indicates the net total amount of the requested articles. The purchase requisition 900 is sent to the procurement unit 420.

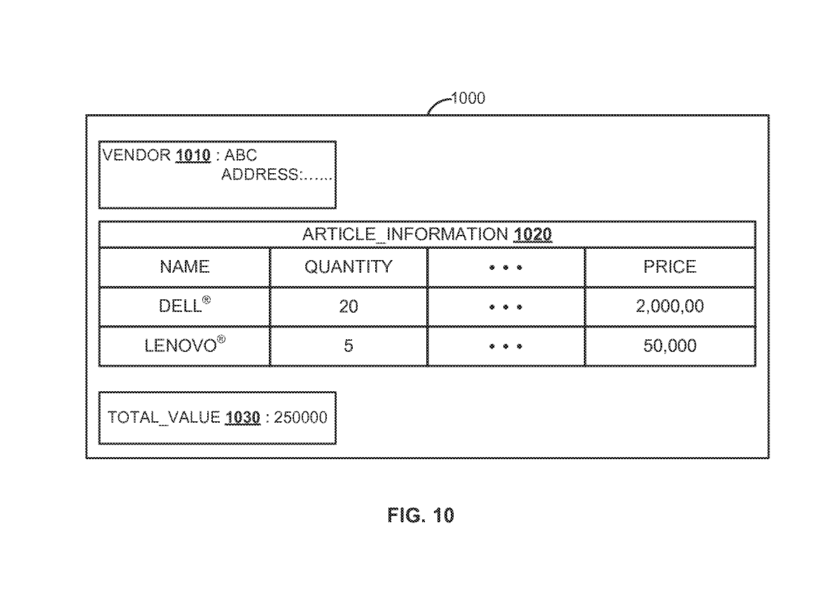

The procurement manager converts the purchase requisition 900 into a purchase order 1000, as shown in FIG. 10, according to one embodiment. The purchase order 1000 may include fields VENDOR 1010, ARTICLE_INFORMATION 1020 and TOTAL_VALUE 1030 corresponding to the fields of purchase requisition 900 in FIG. 9. Accordingly, VENDOR 1010 field in the purchase order 1000 includes the name and address of the vendor. The VENDOR 1010 information may be assigned by the procurement manager. In one embodiment, the procurement manager decides the vendor and creates the purchase order 1000 with an assignment of vendor, e.g., “ABC”. The purchase order 1000 is stored in the procurement unit 420. In one embodiment, the procurement unit 420 stores the information related to the purchase order 1000 in its purchase database table (not shown).

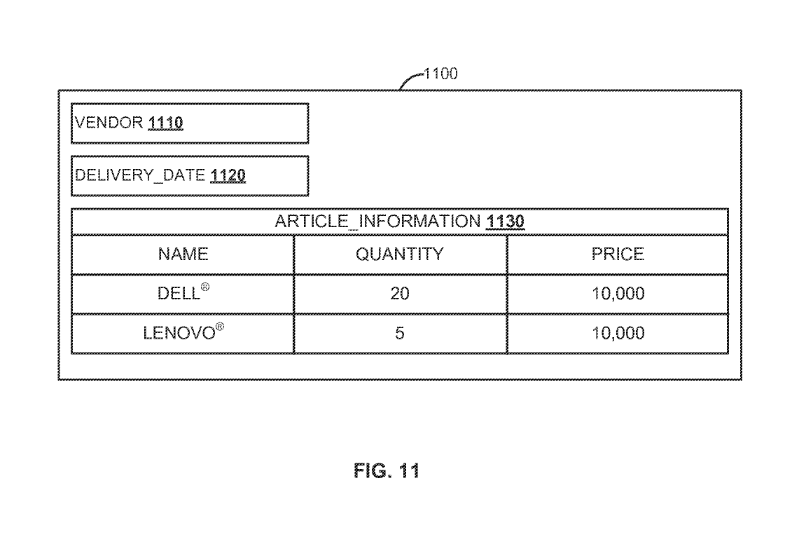

In one embodiment, once the purchase order 1000 is created, the procurement unit 420 informs the routing unit 110. The procurement unit 420 sends the purchase order 1000 to the routing unit 110. Based upon the purchase order 1000, the routing unit 110 generates an inbound delivery 1100 (FIG. 11). The inbound delivery 1100 includes fields such as VENDOR 1110, DELIVERY_DATE 1120, and ARTICLE_INFORMATION 1130. The VENDOR 1110 field indicates the name of the vendor delivering the articles, DELIVERY_DATE 1120 field indicates the date by which the articles has to be delivered, and the ARTICLE_INFORMATION 1130 includes the information related to the requested articles such as name of the article, quantity to be delivered, etc. The routing unit 110 sends the inbound delivery 1100 to the warehouse unit 440.

The warehouse unit 440 stores the inbound delivery 1100. In one embodiment, the warehouse unit 440 stores the information related to the inbound delivery 1100 in a warehouse database (not shown). Once a warehouse manager receives the article from the vendor, the warehouse unit 440 informs the routing unit 110 about the issuance of the articles. Based upon the information, the routing unit 110 updates the database 300. In one embodiment, the routing unit 110 informs the finance unit 430 about the issuance of requested articles from the vendor. Based upon the billing, the finance unit 430 makes the vendor payment. Typically, a finance accountant makes payment to the vendor. The vendor payment information is stored in the finance unit 430, The finance unit 430 may inform the routing unit 110 about the vendor payment.

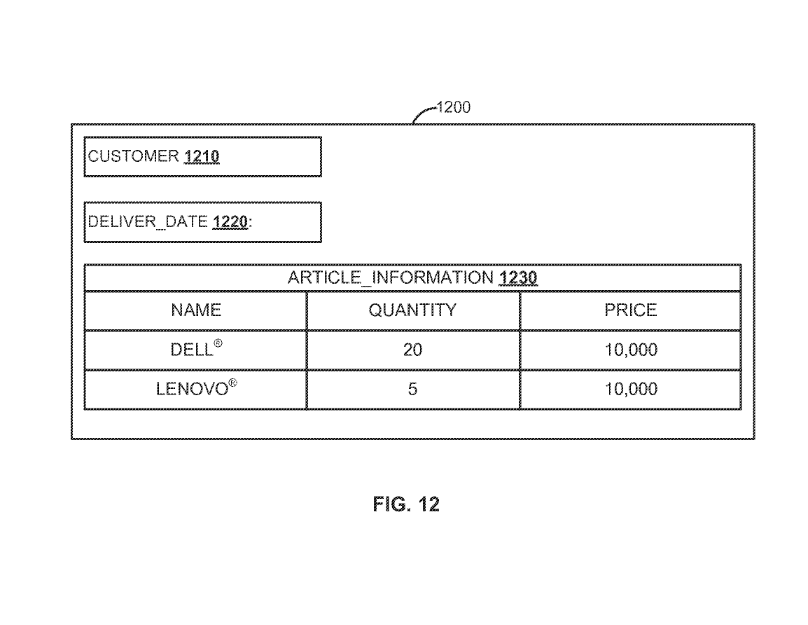

In one embodiment, the warehouse unit 440 generates an outbound delivery 1200 (as shown in FIG. 12). The outbound delivery 1200 includes fields such as CUSTOMER 1210, DELIVERY_DATE 1220, and ARTICLE _INFORMATION 1230, CUSTOMER 1210 field indicates the name of the customer, DELIVERY_DATE 1220 field indicates the date by which the product is to be delivered, and ARTICLE_INFORMATION 1230 indicates information related to the articles such as name of article, quantity to be delivered, etc. In one embodiment, the warehouse unit 440 sends the outbound delivery 1200 to the routing unit 110. The routing unit 110 updates the database table 300 based upon the outbound delivery 1200.

The warehouse unit 440 issues the requested articles to the customer based upon the outbound delivery 1200. The warehouse unit 440 informs the routing unit 110 about the issuance of the articles to the customer. The routing unit 110 informs the finance unit 430. The routing unit 110 may generate the billing for the customer and sends the billing to the finance unit 430, The routing unit 110 ma send the billing to the finance unit 430 when the sales order 500 is created. Once the issuance of the articles is confirmed, the finance unit 430 dispatches the billing to the customer “XYZ”.

In one embodiment, the routing unit 110 is configured to update the chief executive unit 450 (FIG. 4) on revenue generation, For example, the routing unit 110 may inform the chief executive unit 450 on net value of a new order. Therefore, chief officers can be updated in real-time about on revenue generation and other information they might be interested in.

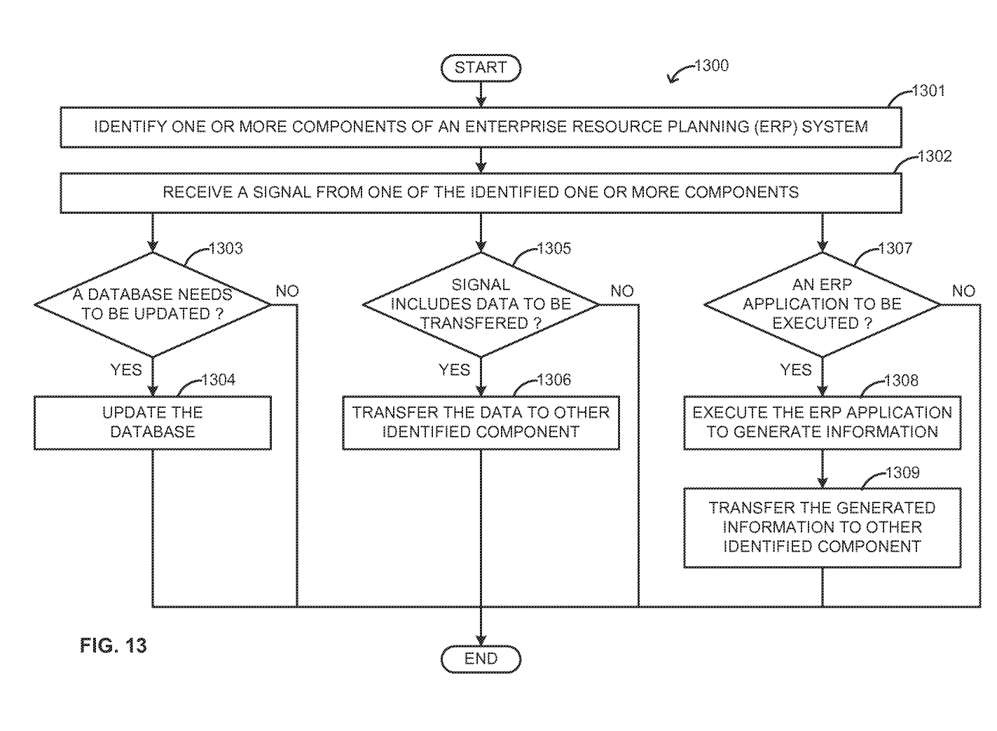

FIG. 13 is a flowchart illustrating process 1300 to manage flow of information between components of a distributed ERP system, e.g., the components C1-CN of the distributed ERP system 100 in FIG. 2., according to an embodiment. The components (e.g., C1-CN) of the distributed ERP system (e.g., ERP system 100) are identified at 1301. In one embodiment, the routing unit 110 (FIG. 2) identifies the components C1-CN by referring the register that includes the name and IP address of the registered components. Once the components C1-CN are identified, the routing unit 110 receives a signal from one or more of the identified components, e.g., C1, at 1302. Based upon the received signal, the routing unit 110 may perform various tasks. In one embodiment, the routing unit 110 analyzes inventory or database, e.g., table 300 (FIG. 3), to determine the tasks to be performed. For example, the routing unit 110 analyzes the database table 300 to determine whether to update the database table 300 at 1303. At 1304, the routing unit 110 updates the database table 300.

In one embodiment, at 1305, the routing unit 110 determines whether the received signal includes data that needs to be transferred to another identified component. When the signal includes such data, the routing unit 110 transfers the data to the other identified component at 1306.

In one embodiment, at 1307, the routing unit 110 determines whether the application related to ERP is required to be executed, For example, the routing unit 110 reads the database table 300 to determine whether the application, e.g., the material resource planning application, is required to be executed. When the execution of the application is required, the routing unit 110 may execute the application to generate information to be transferred to other identified component at 1308, in one embodiment, the generated information may comprise document, e.g., the purchase requisition. The generated information may be transferred to another identified component at 1309.

Embodiments describe a system and method for a distributed ERP. In the distributed ERP, a number of distributed components may include their respective databases and applications, e.g., on premise. Therefore, the component can perform tasks without being connected to a central server, e.g., in an offline mode, without interruption. Further, as the components maintain their data locally, the data may be locally and/or privately protected. Furthermore, an efficient routine mechanism can be easily implemented to regulate a flow of information between the components. Thus, the time and cost involved in installing costly and sizable server may be saved.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium, Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

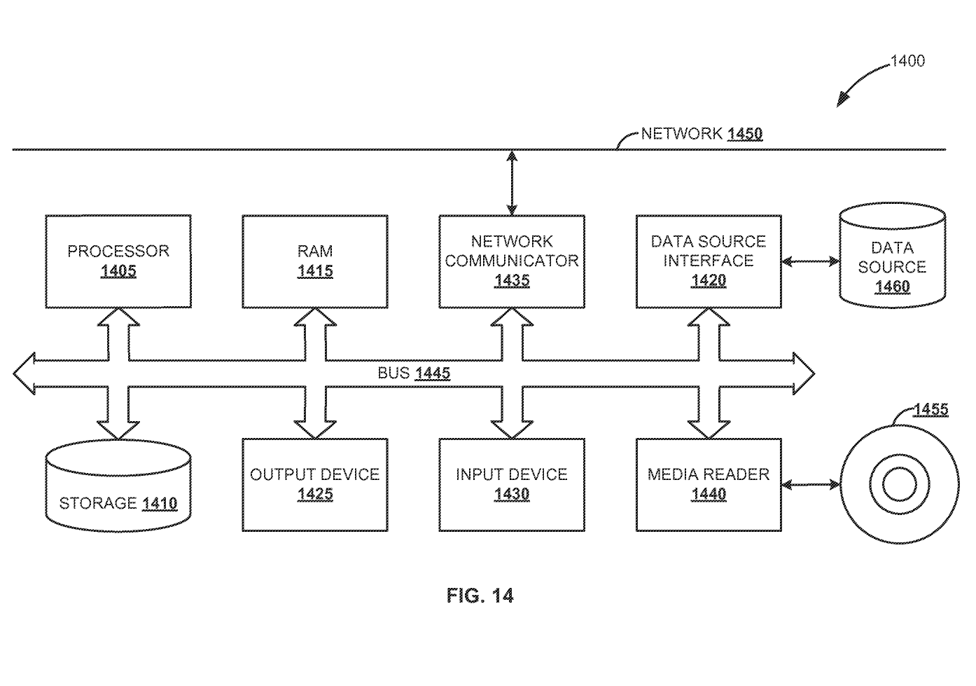

FIG. 14 is a block diagram of an exemplary computer system 1400. The computer system 1400 includes a processor 1405 that executes software instructions or code stored on a computer readable storage medium 1455 to perform the above-illustrated methods. The processor 1405 can include a plurality of cores. The computer system 1400 includes a media reader 1440 to read the instructions from the computer readable storage medium 1455 and store the instructions in storage 1410 or in random access memory (RAM) 1415, The storage 1410 provides a large space for keeping static data where at least some instructions could be stored for later execution. According to some embodiments, such as some in-memory computing system embodiments, the RAM 1415 can have sufficient storage capacity to store much of the data required for processing in the RAM 1415 instead of in the storage 1410. In some embodiments, all of the data required for processing may be stored in the RAM 1415. The stored instructions may be further compiled to generate other representations of the instructions and dynamically stored in the RAM 1415. The processor 1405 reads instructions from the RAM 1415 and performs actions as instructed. According to one embodiment, the computer system 1400 further includes an output device 1425 (e.g., a display) to provide at least some of the results of the execution as output including, but not limited to, visual information to users and an input device 1430 to provide a user or another device with means for entering data and/or otherwise interact with the computer system 1400. Each of these output devices 1425 and input devices 1430 could be joined by one or more additional peripherals to further expand the capabilities of the computer system 1400. A network communicator 1435 may be provided to connect the computer system 1400 to a network 1450 and in turn to other devices connected to the network 1450 including other clients, servers, data stores, and interfaces, for instance. The modules of the computer system 1400 are interconnected via a bus 1445. Computer system 1400 includes a data source interface 1420 to access data source 1460. The data source 1460 can be accessed via one or more abstraction layers implemented in hardware or software. For example, the data source 1460 may be accessed by network 1450. in some embodiments the data source 1460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data Source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details Of with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. An article of manufacture including a non-transitory computer readable storage medium to tangibly store instructions, which when executed cause a computer to:
identify one or more components of an enterprise resource planning system;
receive a signal from one of the identified one or more components; and
based upon the received signal, perform at least one of:
updating a database table related to an inventory of the enterprise resource planning system;
executing an application to generate information to be sent to another component of the identified one or more components; and
when the signal includes a data to be transferred, transferring the data to a component of the identified one or more components.

2. The article of manufacture of claim 1, wherein the signal is automatically sent by the one of the identified one or more components in response to completion of a task.

3. The article of manufacture of claim 2, wherein the task comprises generation of a sales order.

4. The article of manufacture of claim 1, wherein the signal comprises at east one of an instruction and a document.

5. The article of manufacture of claim 4, wherein the document comprises at least one of a sales order and a purchase order.

6. The article of manufacture of claim 1, wherein the application comprises a material requirement planning application.

7. The article of manufacture of claim 1, wherein the generated information comprises at least one of a purchase requisition and a delivery order.

8. The article of manufacture of claim 1 further comprising instructions which when executed cause the computer to:
based upon the signal, read the database table related to inventory; and
based upon the reading, determine whether to execute the application to generate the information to be sent to the another of the identified one or more components.

9. A computer-implemented -t d for a distributed enterprise resource planning, the method comprising:
identifying one or more components of an enterprise resource planning system;
receiving a signal from one of the identified one or more components; and
based upon the received signal, performing at least one of:
updating a database table related to inventory of the enterprise resource planning system;
executing an application to generate information to be sent o another component of the identified one or more components; and
when the signal includes a data to be transferred, transferring the data to a component of the identified one or more components.

10. The method of claim 9 further comprising:
based upon the signal, reading the database table related to inventory; and
based upon the reading, determining whether to execute the application to generate the information to be sent to the another of the identified one or more components.

11. A computer system for a distributed enterprise resource planning, the system comprising:
a memory to store program code; and
a processor communicatively coupled to the memory, the processor configured to execute the program code to:
identify one or more components of an enterprise resource planning system;
receive a signal from one of the identified one or more components; and
based upon the received signal, perform at least one of:
updating a database table related to inventory of the enterprise resource planning system;
executing an application to generate information to be sent to another component of the identified one or more components; and
when the signal includes a data to be transferred, transferring the data to a component of the identified one or more components.

12. The computer system of claim 11, wherein the one or more components comprise one or more functional units of the enterprise resource planning system.

13. The computer system of claim 11, wherein the signal is automatically sent by the one of the identified one or more components in response to completion of a task.

14. The computer system of claim 13, wherein the task comprises a generation of a sales order.

15. The computer system of claim 11, wherein the generated information comprises at least one of a purchase requisition and a delivery order.

16. The computer system of claim 11, wherein the application comprises a material requirement planning application.

17. The computer system of claim 11, wherein the signal comprises at least one of an instruction and a document.

18. The computer system of claim 17, wherein the document comprises at least one of a sales order and a purchase order.

19. The computer system of claim 11, wherein the processor is further configured to execute the program code to:
based upon the signal, read the database table related to inventory; and
based upon the reading, determine whether to execute the application to generate the information to be sent to the another of the identified one or more components.

20. An article of manufacture including a non-transitory computer readable storage medium to tangibly store instructions, which when executed cause a computer to:
identify one or more components of an enterprise resource planning system;
receive a signal from one of the identified one or more components; and
based upon the received signal, perform at least one of:
updating a database table related to an inventory of the enterprise resource planning system;
when the signal includes a data to be transferred, transferring the data to a component of the identified one or more components;
determining whether to execute an application to generate the information to be sent to another of the identified one or more components;
based upon the determination, executing the application to generate the information; and
sending the generated information to the another component of the identified one or more components.
